(19) United States
(12) Patent Application Publication
(10) Pub. No.: US 2009/0165022 A1
(43) Pub. Date: Jun. 25, 2009

(54) SYSTEM AND METHOD FOR SCHEDULING ELECTRONIC EVENTS

(76) Inventors: Mark Hunter Madsen, Toronto (CA); Cameron Marlow, New York, NY (US); Ronald Martinez, San Francisco, CA (US); Marc Eliot Davis, San Francisco, CA (US); Marco Boerries, Los Altos Hills, CA (US); Christopher William Higgins, Portland, OR (US); Joseph James O'Sullivan, Oakland, CA (US); Robert Carter Trout, Burlingame, CA (US)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 11/960,368

(22) Filed: Dec. 19, 2007

(51) Int. Cl. G06F 9/44

(52) U.S. Cl. 719/318

(57) ABSTRACT

The disclosure describes systems and methods for scheduling an event in which user data, which may include social data, spatial data, temporal data and logical data, associated with each of the designated attendees of the event is used to prioritize and optimally schedule the event. Based on user data collected from past interactions with the network, for each attendee a priority score is generated for the event based on a comparison of the attendee's user data and the event information. One or more proposed alternate events are then identified based on the various attendees' priority scores of the event and their previously scheduled events. The organizer of the event may then select one of the proposed alternate events which is subsequently added to the attendees' electronic calendars.

### BACKGROUND

A great deal of information is generated when people use electronic devices, such as when people use mobile phones and cable set-top boxes. Such information, such as location, applications used, social network, physical and online locations visited, to name a few, could be used to deliver useful services and information to end users, and provide commercial opportunities to advertisers and retailers. However, most of this information is effectively abandoned due to deficiencies in the way such information may be captured. For example, and with respect to a mobile phone, information is generally not gathered while the mobile phone is idle (i.e., not being used by a user). Other information, such as presence of others in the immediate vicinity, time and frequency of messages to other users, and activities of a user's social network are also not captured effectively.

### SUMMARY

This disclosure describes systems and methods for using data collected and stored by multiple devices on a network in order to improve the performance of the services provided via the network. In particular, the disclosure describes systems and methods for scheduling an event in which user data, which may include social data, spatial data, temporal data and logical data, associated with each of the designated attendees of the event is used to prioritize and optimally schedule the event. Based on user data collected from past interactions with the network, for each attendee a priority score is generated for the event based on a comparison of the attendee's user data and the event information. One or more proposed alternate events are then identified based on the various attendees' priority scores of the event and their previously scheduled events. The organizer of the event may then select one of the proposed alternate events which is subsequently added to the attendees' electronic calendars.

One aspect of the disclosure is a method for scheduling an event that includes receiving a request from an event organizer to schedule a future event, such request identifying future event information including a topic and a list of attendees. The method then retrieves user data associated with each of the attendees and, for each attendee, generates a priority score for the future event based on a comparison of the attendee's user data and the event information. The method also includes identifying one or more proposed events based on each attendee's priority score for the future event and receiving a selection of a proposed event from the event organizer to be used as the future event. The method then adds the future event to attendees' calendars in response to receiving the selection.

In another aspect, the disclosure describes a system for scheduling events. The system is embodied in one or more computing devices and attached computer-readable media that operate as a prioritization engine and a scheduling engine. The computer-readable media stores at least one of social data, spatial data, temporal data and logical data associated with a plurality of attendees derived from information objects (IOs) transmitted between computing devices via at least one communication network. The prioritization engine, based on the detection of a request from an event organizer to schedule a future event with a list of attendees including a first attendee, generates a priority score for each attendee of the future event based on the at least one of social data, spatial data, temporal data and logical data. The scheduling engine that transmits to the event organizer a list of one or more proposed events determined based on each attendee's priority scores for the future event and previously scheduled events. The system may further include a correlation engine that identifies one or more relationships between the future event, the event organizer and each of the attendees in the list of attendees in which case the prioritization engine generates a priority score for each attendee in the list of attendees based on the one or more relationships identified by the correlation engine between that attendee and at least one of the future event, the other attendees in the list of attendees and the event organizer.

In yet another aspect, the disclosure describes a computer-readable medium encoding instructions for performing a method for scheduling a future event. The encoded method includes dynamically identifying one or more relationships between a first event attendee and future event information known about the future event and, based on the identified relationships, generating a priority score for the future event. The method then places the future event on an electronic calendar associated with first event attendee based on the priority score. The method may further include retrieving one or more of social data, spatial data, temporal data and logical data obtained from previous communications associated with the first event attendee and identifying one or more relationships between the first even attendee and the future event information based on the retrieved one or more of social data, spatial data, temporal data and logical data. The previous communications may include one or more of an electronic mail message from one email account to another, a voicemail message transmitted via a telephone network, an instant message transmitted to a computing device, and a prior event record. The method may further include moving at least one previously scheduled event on the electronic calendar based on a comparison of priority scores of the future event and the at least one previously scheduled event.

These and various other features as well as advantages will be apparent from a reading of the following detailed description and a review of the associated drawings. Additional features are set forth in the description that follows and, in part, will be apparent from the description, or may be learned by practice of the described embodiments. The benefits and features will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments systems and methods described below and are not meant to limit the scope of the disclosure in any manner, which scope shall be based on the claims appended hereto.

FIG. 1 illustrates an example of the relationships between RWEs and IOs on the W4 COMN.

FIG. 2 illustrates an example of metadata defining the relationships between RWEs and IOs on the W4 COMN.

FIG. 3 illustrates a conceptual model of the W4 COMN.

FIG. 4 illustrates the functional layers of the W4 COMN architecture.

FIG. 5 illustrates an embodiment of analysis components of a W4 engine as shown in FIG. 2.

FIG. 6 illustrates an embodiment of a W4 engine showing different components within the sub-engines described generally above with reference to FIG. 5.

FIG. 7 illustrates some of the elements in a W4 engine adapted to schedule events based on W4 data.

FIG. 8 illustrates an embodiment of a method for scheduling events using social, temporal, spatial and topical data for entities on the network.

### DETAILED DESCRIPTION

This disclosure describes a communication network, referred herein as the “W4 Communications Network” or W4 COMN, that uses information related to the “Who, What, When and Where” of interactions with the network to provide improved services to the network's users. The W4 COMN is a collection of users, devices and processes that foster both synchronous and asynchronous communications between users and their proxies. It includes an instrumented network of sensors providing data recognition and collection in real-world environments about any subject, location, user or combination thereof.

As a communication network, the W4 COMN handles the routing/addressing, scheduling, filtering, prioritization, replying, forwarding, storing, deleting, privacy, transacting, triggering of a new message, propagating changes, transcoding and linking. Furthermore, these actions can be performed on any communication channel accessible by the W4 COMN.

The W4 COMN uses a data modeling strategy for creating profiles for not only users and locations but also any device on the network and any kind of user-defined data with user-specified conditions from a rich set of possibilities. Using Social, Spatial, Temporal and Logical data available about a specific user, topic or logical data object, every entity known to the W4 COMN can be mapped and represented against all other known entities and data objects in order to create both a micro graph for every entity as well as a global graph that interrelates all known entities against each other and their attributed relations.

In order to describe the operation of the W4 COMN, two elements upon which the W4 COMN is built must first be introduced, real-world entities and information objects. These distinction are made in order to enable correlations to be made from which relationships between electronic/logical objects and real objects can be determined. A real-world entity (RWE) refers to a person, device, location, or other physical thing known to the W4 COMN. Each RWE known to the W4 COMN is assigned or otherwise provided with a unique W4 identification number that absolutely identifies the RWE within the W4 COMN.

RWEs may interact with the network directly or through proxies, which may themselves be RWEs. Examples of RWEs that interact directly with the W4 COMN include any device such as a sensor, motor, or other piece of hardware that connects to the W4 COMN in order to receive or transmit data or control signals. Because the W4 COMN can be adapted to use any and all types of data communication, the devices that may be RWEs include all devices that can serve as network nodes or generate, request and/or consume data in a networked environment or that can be controlled via the network. Such devices include any kind of “dumb” device purpose-designed to interact with a network (e.g., cell phones, cable television set top boxes, fax machines, telephones, and radio frequency identification (RFID) tags, sensors, etc.). Typically, such devices are primarily hardware and their operations can not be considered separately from the physical device.

Examples of RWEs that must use proxies to interact with W4 COMN network include all non-electronic entities including physical entities, such as people, locations (e.g., states, cities, houses, buildings, airports, roads, etc.) and things (e.g., animals, pets, livestock, gardens, physical objects, cars, airplanes, works of art, etc.), and intangible entities such as business entities, legal entities, groups of people or sports teams. In addition, “smart” devices (e.g., computing devices such as smart phones, smart set top boxes, smart cars that support communication with other devices or networks, laptop computers, personal computers, server computers, satellites, etc.) are also considered RWEs that must use proxies to interact with the network. Smart devices are electronic devices that can execute software via an internal processor in order to interact with a network. For smart devices, it is actually the executing software application(s) that interact with the W4 COMN and serve as the devices' proxies.

The W4 COMN allows associations between RWEs to be determined and tracked. For example, a given user (an RWE) may be associated with any number and type of other RWEs including other people, cell phones, smart credit cards, personal data assistants, email and other communication service accounts, networked computers, smart appliances, set top boxes and receivers for cable television and other media services, and any other networked device. This association may be made explicitly by the user, such as when the RWE is installed into the W4 COMN. An example of this is the set up of a new cell phone, cable television service or email account in which a user explicitly identifies an RWE (e.g., the user's phone for the cell phone service, the user's set top box and/or a location for cable service, or a username and password for the online service) as being directly associated with the user. This explicit association may include the user identifying a specific relationship between the user and the RWE (e.g., this is my device, this is my home appliance, this person is my friend/father/son/etc., this device is shared between me and other users, etc.). RWEs may also be implicitly associated with a user based on a current situation. For example, a weather sensor on the W4 COMN may be implicitly associated with a user based on information indicating that the user lives or is passing near the sensor's location.

An information object (IO), on the other hand, is a logical object that stores, maintains, generates, serves as a source for or otherwise provides data for use by RWEs and/or the W4 COMN. IOs are distinct from RWEs in that IOs represent data, whereas RWEs may create or consume data (often by creating or consuming IOs) during their interaction with the W4 COMN. Examples of IOs include passive objects such as communication signals (e.g., digital and analog telephone signals, streaming media and interprocess communications), email messages, transaction records, virtual cards, event records (e.g., a data file identifying a time, possibly in combination with one or more RWEs such as users and locations, that may further be associated with a known topic/activity/significance such as a concert, rally, meeting, sporting event, etc.), recordings of phone calls, calendar entries, web pages, database entries, electronic media objects (e.g., media files containing songs, videos, pictures, images, audio messages, phone calls, etc.), electronic files and associated metadata.

In addition, IOs include any executing process or application that consumes or generates data such as an email communication application (such as OUTLOOK by MICROSOFT, or YAHOO! MAIL by YAHOO!), a calendaring application, a word processing application, an image editing application, a media player application, a weather monitoring application, a browser application and a web page server application. Such active IOs may or may not serve as a proxy for one or more RWEs. For example, voice communication software on a smart phone may serve as the proxy for both the smart phone and for the owner of the smart phone.

An IO in the W4 COMN may be provided a unique W4 identification number that absolutely identifies the IO within the W4 COMN. Although data in an IO may be revised by the act of an RWE, the IO remains a passive, logical data representation or data source and, thus, is not an RWE.

For every IO there are at least three classes of associated RWEs. The first is the RWE who owns or controls the IO, whether as the creator or a rights holder (e.g., an RWE with editing rights or use rights to the IO). The second is the RWE(s) that the IO relates to, for example by containing information about the RWE or that identifies the RWE. The third are any RWEs who then pay any attention (directly or through a proxy process) to the IO, in which “paying attention” refers to accessing the IO in order to obtain data from the IO for some purpose.

“Available data” and “W4 data” means data that exists in an IO in some form somewhere or data that can be collected as needed from a known IO or RWE such as a deployed sensor. “Sensor” means any source of W4 data including PCs, phones, portable PCs or other wireless devices, household devices, cars, appliances, security scanners, video surveillance, RFID tags in clothes, products and locations, online data or any other source of information about a real-world user/topic/thing (RWE) or logic-based agent/process/topic/thing (IO).

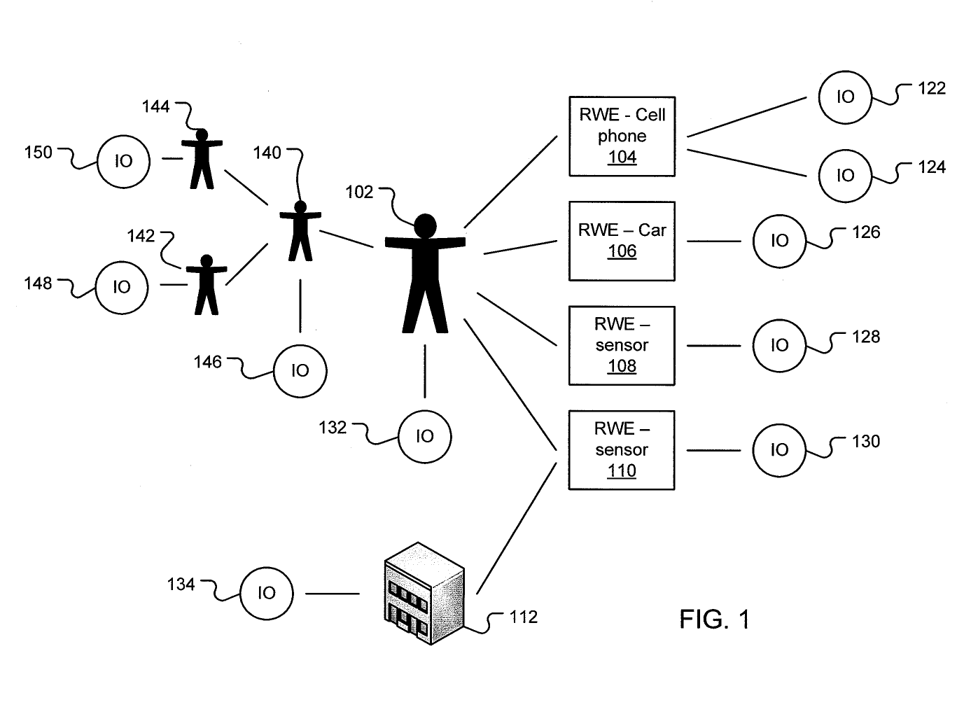

FIG. 1 illustrates an example of the relationships between RWEs and IOs on the W4 COMN. In the embodiment illustrated, a user 102 is a RWE of the network provided with a unique network ID. The user 102 is a human that communicates with the network via the proxy devices 104, 106, 108, 110 associated with the user 102, all of which are RWEs of the network and provided with their own unique network ID. Some of these proxies may communicate directly with the W4 COMN or may communicate with the W4 COMN via IOs such as applications executed on or by the device.

As mentioned above the proxy devices 104, 106, 108, 110 may be explicitly associated with the user 102. For example, one device 104 may be a smart phone connected by a cellular service provider to the network and another device 106 may be a smart vehicle that is connected to the network. Other devices may be implicitly associated with the user 102. For example, one device 108 may be a “dumb” weather sensor at a location matching the current location of the user's cell phone 104, and thus implicitly associated with the user 102 while the two RWEs 104, 108 are co-located. Another implicitly associated device 110 may be a sensor 110 for physical location 112 known to the W4 COMN. The location 112 is known, either explicitly (through a user-designated relationship, e.g., this is my home, place of employment, parent, etc.) or implicitly (the user 102 is often co-located with the RWE 112 as evidenced by data from the sensor 110 at that location 112), to be associated with the first user 102.

The user 102 may also be directly associated with other people, such as the person 140 shown, and then indirectly associated with other people 142, 144 through their associations as shown. Again, such associations may be explicit (e.g., the user 102 may have identified the associated person 140 as his/her father, or may have identified the person 140 as a member of the user's social network) or implicit (e.g., they share the same address).

Tracking the associations between people (and other RWEs as well) allows the creation of the concept of “intimacy”: Intimacy being a measure of the degree of association between two people or RWEs. For example, each degree of removal between RWEs may be considered a lower level of intimacy, and assigned lower intimacy score. Intimacy may be based solely on explicit social data or may be expanded to include all W4 data including spatial data and temporal data.

Each RWE 102, 104, 106, 108, 110, 112, 140, 142, 144 of the W4 COMN may be associated with one or more IOs as shown. Continuing the examples discussed above, FIG. 1 illustrates two IOs 122, 124 as associated with the cell phone device 104. One IO 122 may be a passive data object such as an event record that is used by scheduling/calendaring software on the cell phone, a contact IO used by an address book application, a historical record of a transaction made using the device 104 or a copy of a message sent from the device 104. The other IO 124 may be an active software process or application that serves as the device's proxy to the W4 COMN by transmitting or receiving data via the W4 COMN. Voice communication software, scheduling/calendaring software, an address book application or a text messaging application are all examples of IOs that may communicate with other IOs and RWEs on the network. The IOs 122, 124 may be locally stored on the device 104 or stored remotely on some node or datastore accessible to the W4 COMN, such as a message server or cell phone service datacenter. The IO 126 associated with the vehicle 108 may be an electronic file containing the specifications and/or current status of the vehicle 108, such as make, model, identification number, current location, current speed, current condition, current owner, etc. The IO 128 associated with sensor 108 may identify the current state of the subject(s) monitored by the sensor 108, such as current weather or current traffic. The IO 130 associated with the cell phone 110 may be information in a database identifying recent calls or the amount of charges on the current bill.

Furthermore, those RWEs which can only interact with the W4 COMN through proxies, such as the people 102, 140, 142, 144, computing devices 104, 106 and location 112, may have one or more IOs 132, 134, 146, 148, 150 directly associated with them. An example includes IOs 132, 134 that contain contact and other RWE-specific information. For example, a person's IO 132, 146, 148, 150 may be a user profile containing email addresses, telephone numbers, physical addresses, user preferences, identification of devices and other RWEs associated with the user, records of the user's past interactions with other RWE's on the W4 COMN (e.g., transaction records, copies of messages, listings of time and location combinations recording the user's whereabouts in the past), the unique W4 COMN identifier for the location and/or any relationship information (e.g., explicit user-designations of the user's relationships with relatives, employers, co-workers, neighbors, service providers, etc.). Another example of a person's IO 132, 146, 148, 150 includes remote applications through which a person can communicate with the W4 COMN such as an account with a web-based email service such as Yahoo! Mail. The location's IO 134 may contain information such as the exact coordinates of the location, driving directions to the location, a classification of the location (residence, place of business, public, non-public, etc.), information about the services or products that can be obtained at the location, the unique W4 COMN identifier for the location, businesses located at the location, photographs of the location, etc.

In order to correlate RWEs and IOs to identify relationships, the W4 COMN makes extensive use of existing metadata and generates additional metadata where necessary. Metadata is loosely defined as data that describes data. For example, given an IO such as a music file, the core, primary or object data of the music file is the actual music data that is converted by a media player into audio that is heard by the listener. Metadata for the same music file may include data identifying the artist, song, etc., album art, and the format of the music data. This metadata may be stored as part of the music file or in one or more different IOs that are associated with the music file or both. In addition, W4 metadata for the same music file may include the owner of the music file and the rights the owner has in the music file. As another example, if the IO is a picture taken by an electronic camera, the picture may include in addition to the primary image data from which an image may be created on a display, metadata identifying when the picture was taken, where the camera was when the picture was taken, what camera took the picture, who, if anyone, is associated (e.g., designated as the camera's owner) with the camera, and who and what are the subjects of tin the picture. The W4 COMN uses all the available metadata in order to identify implicit and explicit associations between entities and data objects.

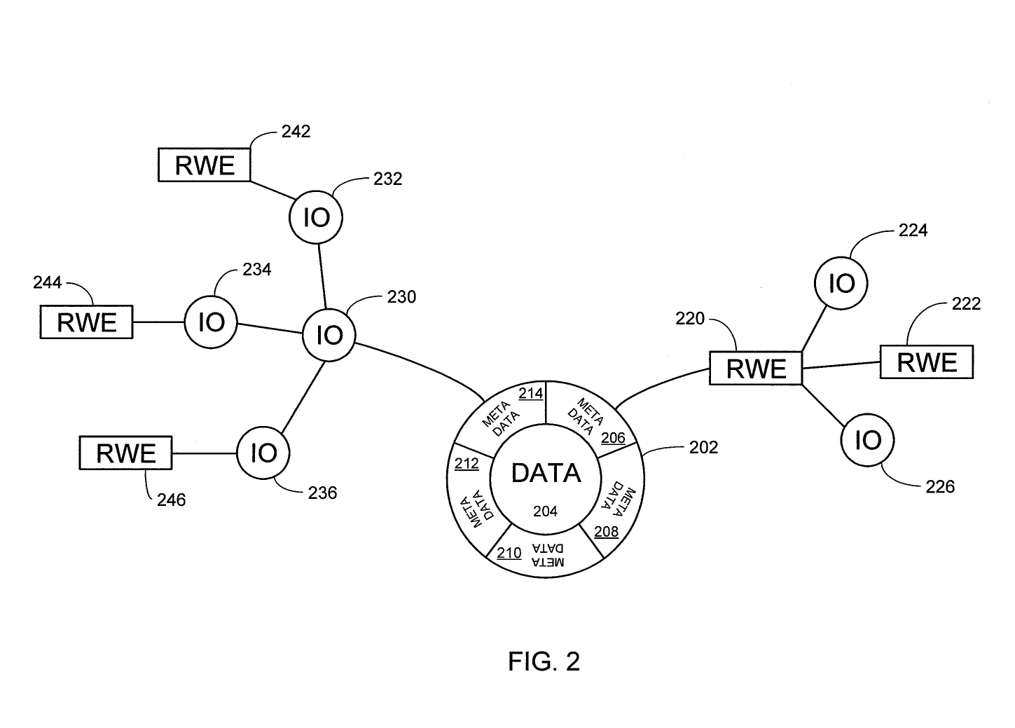

FIG. 2 illustrates an example of metadata defining the relationships between RWEs and IOs on the W4 COMN. In the embodiment shown, an IO 202 includes object data 204 and five discrete items of metadata 206, 208, 210, 212, 214. Some items of metadata 208, 210, 212 may contain information related only to the object data 204 and unrelated to any other IO or RWE. For example, a creation date, text or an image that is to be associated with the object data 204 of the IO 202.

Some of items of metadata 206, 214, on the other hand, may identify relationships between the IO 202 and other RWEs and IOs. As illustrated, the IO 202 is associated by one item of metadata 206 with an RWE 220 that RWE 220 is further associated with two IOs 224, 226 and a second RWE 222 based on some information known to the W4 COMN. This part of FIG. 2, for example, could describe the relations between a picture (IO 202) containing metadata 206 that identifies the electronic camera (the first RWE 220) and the user (the second RWE 224) that is known by the system to be the owner of the camera 220. Such ownership information may be determined, for example, from one or another of the IOs 224, 226 associated with the camera 220.

FIG. 2 also illustrates metadata 214 that associates the IO 202 with another IO 230. This IO 230 is itself associated with three other IOs 232, 234, 236 that are further associated with different RWEs 242, 244, 246. This part of FIG. 2, for example, could describe the relations between a music file (IO 202) containing metadata 206 that identifies the digital rights file (the first IO 230) that defines the scope of the rights of use associated with this music file 202. The other IOs 232, 234, 236 are other music files that are associated with the rights of use and which are currently associated with specific owners (RWEs 242, 244, 246).

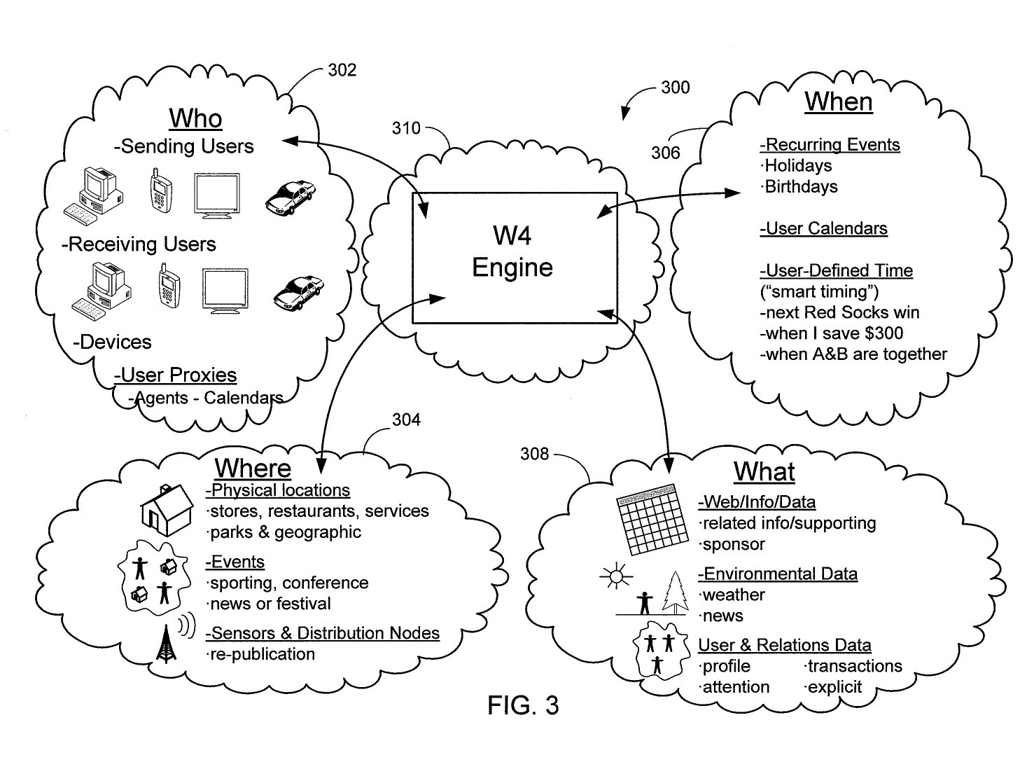

FIG. 3 illustrates a conceptual model of the W4 COMN. The W4 COMN 300 creates an instrumented messaging infrastructure in the form of a global logical network cloud conceptually sub-divided into networked-clouds for each of the 4Ws: Who, Where, What and When. In the Who cloud 302 are all users whether acting as senders, receivers, data points or confirmation/certification sources as well as user proxies in the forms of user-program processes, devices, agents, calendars, etc. In the Where cloud 304 are all physical locations, events, sensors or other RWEs associated with a spatial reference point or location. The When cloud 306 is composed of natural temporal events (that is events that are not associated with particular location or person such as days, times, seasons) as well as collective user temporal events (holidays, anniversaries, elections, etc.) and user-defined temporal events (birthdays, smart-timing programs). The What cloud 308 is comprised of all known data—web or private, commercial or user—accessible to the W4 COMN, including for example environmental data like weather and news, RWE-generated data, IOs and IO data, user data, models, processes and applications. Thus, conceptually, most data is contained in the What cloud 308.

As this is just a conceptual model, it should be noted that some entities, sensors or data will naturally exist in multiple clouds either disparate in time or simultaneously. Additionally, some IOs and RWEs may be composites in that they combine elements from one or more clouds. Such composites may be classified or not as appropriate to facilitate the determination of associations between RWEs and IOs. For example, an event consisting of a location and time could be equally classified within the When cloud 306, the What cloud 308 and/or the Where cloud 304.

The W4 engine 310 is center of the W4 COMN's central intelligence for making all decisions in the W4 COMN. An “engine” as referred to herein is meant to describe a software, hardware or firmware (or combinations thereof) system, process or functionality that performs or facilitates the processes, features and/or functions described herein (with or without human interaction or augmentation). The W4 engine 310 controls all interactions between each layer of the W4 COMN and is responsible for executing any approved user or application objective enabled by W4 COMN operations or interoperating applications. In an embodiment, the W4 COMN is an open platform upon which anyone can write an application. To support this, it includes standard published APIs for requesting (among other things) synchronization, disambiguation, user or topic addressing, access rights, prioritization or other value-based ranking, smart scheduling, automation and topical, social, spatial or temporal alerts.

One function of the W4 COMN is to collect data concerning all communications and interactions conducted via the W4 COMN, which may include storing copies of IOs and information identifying all RWEs and other information related to the IOs (e.g., who, what, when, where information). Other data collected by the W4 COMN may include information about the status of any given RWE and IO at any given time, such as the location, operational state, monitored conditions (e.g., for an RWE that is a weather sensor, the current weather conditions being monitored or for an RWE that is a cell phone, its current location based on the cellular towers it is in contact with) and current status.

The W4 engine 310 is also responsible for identifying RWEs and relationships between RWEs and IOs from the data and communication streams passing through the W4 COMN. The function of identifying RWEs associated with or implicated by IOs and actions performed by other RWEs is referred to as entity extraction. Entity extraction includes both simple actions, such as identifying the sender and receivers of a particular IO, and more complicated analyses of the data collected by and/or available to the W4 COMN, for example determining that a message listed the time and location of an upcoming event and associating that event with the sender and receiver(s) of the message based on the context of the message or determining that an RWE is stuck in a traffic jam based on a correlation of the RWE's location with the status of a co-located traffic monitor.

It should be noted that when performing entity extraction from an IO, the IO can be an opaque object with only W4 metadata related to the object (e.g., date of creation, owner, recipient, transmitting and receiving RWEs, type of IO, etc.), but no knowledge of the internals of the IO (i.e., the actual primary or object data contained within the object). Knowing the content of the IO does not prevent W4 data about the IO (or RWE) to be gathered. The content of the IO if known can also be used in entity extraction, if available, but regardless of the data available entity extraction is performed by the network based on the available data. Likewise, W4 data extracted around the object can be used to imply attributes about the object itself, while in other embodiments, full access to the IO is possible and RWEs can thus also be extracted by analyzing the content of the object, e.g. strings within an email are extracted and associated as RWEs to for use in determining the relationships between the sender, user, topic or other RWE or IO impacted by the object or process.

In an embodiment, the W4 engine 310 represents a group of applications executing on one or more computing devices that are nodes of the W4 COMN. For the purposes of this disclosure, a computing device is a device that includes a processor and memory for storing data and executing software (e.g., applications) that perform the functions described. Computing devices may be provided with operating systems that allow the execution of software applications in order to manipulate data.

In the embodiment shown, the W4 engine 310 may be one or a group of distributed computing devices, such as a general-purpose personal computers (PCs) or purpose built server computers, connected to the W4 COMN by suitable communication hardware and/or software. Such computing devices may be a single device or a group of devices acting together. Computing devices may be provided with any number of program modules and data files stored in a local or remote mass storage device and local memory (e.g., RAM) of the computing device. For example, as mentioned above, a computing device may include an operating system suitable for controlling the operation of a networked computer, such as the WINDOWS XP or WINDOWS SERVER operating systems from MICROSOFT CORPORATION.

Some RWEs may also be computing devices such as smart phones, web-enabled appliances, PCs, laptop computers, and personal data assistants (PDAs). Computing devices may be connected to one or more communications networks such as the Internet, a publicly switched telephone network, a cellular telephone network, a satellite communication network, a wired communication network such as a cable television or private area network. Computing devices may be connected any such network via a wired data connection or wireless connection such as a wi-fi, a WiMAX (802.36), a Bluetooth or a cellular telephone connection.

Local data structures, including discrete IOs, may be stored on a mass storage device (not shown) that is connected to, or part of, any of the computing devices described herein including the W4 engine 310. For example, in an embodiment, the data backbone of the W4 COMN, discussed below, includes multiple mass storage devices that maintain the IOs, metadata and data necessary to determine relationships between RWEs and IOs as described herein. A mass storage device includes some form of computer-readable media and provides non-volatile storage of data and software for retrieval and later use by one or more computing devices. Although the description of computer-readable media contained herein refers to a mass storage device, such as a hard disk or CD-ROM drive, it should be appreciated by those skilled in the art that computer-readable media can be any available media that can be accessed by a computing device.

By way of example, and not limitation, computer-readable media may comprise computer storage media and communication media. Computer storage media include volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassette, magnetic tape, magnetic disk storage or other magnetic storage devices, or any other medium which can be used to store the desired information and which can be accessed by the computer.

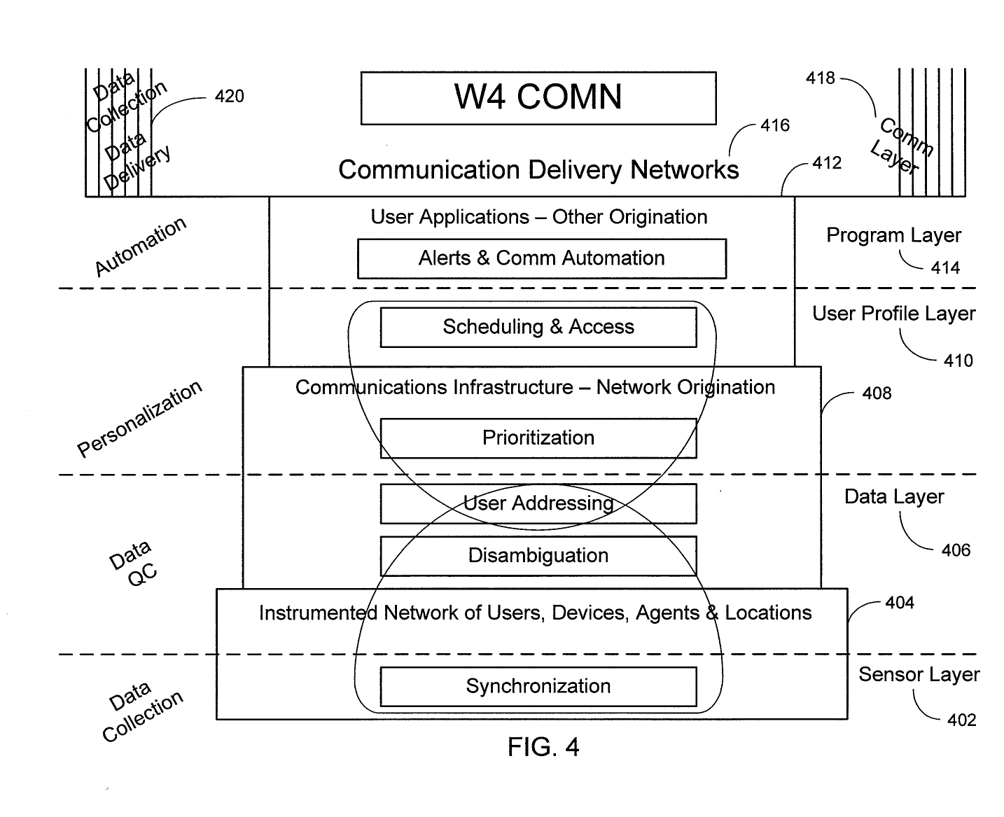

FIG. 4 illustrates the functional layers of the W4 COMN architecture. At the lowest layer, referred to as the sensor layer 402, is the network 404 of the actual devices, users, nodes and other RWEs. The instrumentation of the network nodes to utilize them as sensors include known technologies like web analytics, GPS, cell-tower pings, use logs, credit card transactions, online purchases, explicit user profiles and implicit user profiling achieved through behavioral targeting, search analysis and other analytics models used to optimize specific network applications or functions.

The next layer is the data layer 406 in which the data produced by the sensor layer 402 is stored and cataloged. The data may be managed by either the network 404 of sensors or the network infrastructure 406 that is built on top of the instrumented network of users, devices, agents, locations, processes and sensors. The network infrastructure 408 is the core under-the-covers network infrastructure that includes the hardware and software necessary to receive that transmit data from the sensors, devices, etc. of the network 404. It further includes the processing and storage capability necessary to meaningfully categorize and track the data created by the network 404.

The next layer of the W4 COMN is the user profiling layer 410. This layer 410 may further be distributed between the network infrastructure 408 and user applications/processes 412 executing on the W4 engine or disparate user computing devices. The user profiling layer 410 performs the W4 COMN's user profiling functions. Personalization is enabled across any single or combination of communication channels and modes including email, IM, texting (SMS, etc.), photobloging, audio (e.g. telephone call), video (teleconferencing, live broadcast), games, data confidence processes, security, certification or any other W4 COMM process call for available data.

In one embodiment, the user profiling layer 410 is a logic-based layer above all sensors to which sensor data are sent in the rawest form to be mapped and placed into the W4 COMN data backbone 420. The data (collected and refined, related and deduplicated, synchronized and disambiguated) are then stored in one or a collection of related databases available to all processes of all applications approved on the W4 COMN. All Network-originating actions and communications are based upon the fields of the data backbone, and some of these actions are such that they themselves become records somewhere in the backbone, e.g. invoicing, while others, e.g. fraud detection, synchronization, disambiguation, can be done without an impact to profiles and models within the backbone.

Actions originating from anything other than the network, e.g., RWEs such as users, locations, proxies and processes, come from the applications layer 414 of the W4 COMN. Some applications may be developed by the W4 COMN operator and appear to be implemented as part of the communications infrastructure 408, e.g. email or calendar programs because of how closely they operate with the sensor processing and user profiling layer 410. The applications 412 also serve some role as a sensor in that they, through their actions, generate data back to the data layer 406 via the data backbone concerning any data created or available due to the applications execution.

The applications layer 414 also provides a personalized user interface (UI) based upon device, network, carrier as well as user-selected or security-based customizations. Any UI can operate within the W4 COMN if it is instrumented to provide data on user interactions or actions back to the network. This is a basic sensor function of any W4 COMN application/UI, and although the W4 COMN can interoperate with applications/UIs that are not instrumented, it is only in a delivery capacity and those applications/UIs would not be able to provide any data (let alone the rich data otherwise available from W4-enabled devices.)

In the case of W4 COMN mobile devices, the UI can also be used to confirm or disambiguate incomplete W4 data in real-time, as well as correlation, triangulation and synchronization sensors for other nearby enabled or non-enabled devices. At some point, the network effects of enough enabled devices allow the network to gather complete or nearly complete data (sufficient for profiling and tracking) of a non-enabled device because of its regular intersection and sensing by enabled devices in its real-world location.

Above the applications layer 414 (and sometimes hosted within it) is the communications delivery network(s) 416. This can be operated by the W4 COMN operator or be independent third-party carrier service, but in either case it functions to deliver the data via synchronous or asynchronous communication. In every case, the communication delivery network 414 will be sending or receiving data (e.g., http or IP packets) on behalf of a specific application or network infrastructure 408 request.

The communication delivery layer 418 also has elements that act as sensors including W4 entity extraction from phone calls, emails, blogs, etc. as well as specific user commands within the delivery network context, e.g., “save and prioritize this call” said before end of call may trigger a recording of the previous conversation to be saved and for the W4 entities within the conversation to analyzed and increased in weighting prioritization decisions in the personalization/user profiling layer 410.

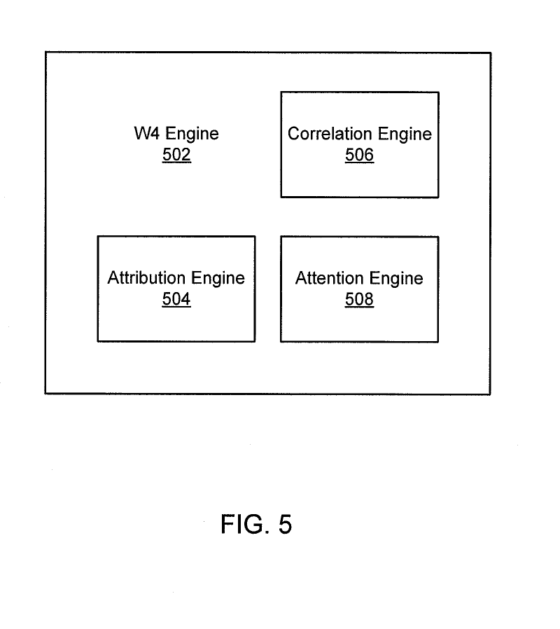

FIG. 5 illustrates an embodiment of analysis components of a W4 engine as shown in FIG. 3. As discussed above, the W4 Engine is responsible for identifying RWEs and relationships between RWEs and IOs from the data and communication streams passing through the W4 COMN.

In one embodiment the W4 engine connects, interoperates and instruments all network participants through a series of sub-engines that perform different operations in the entity extraction process. One such sub-engine is an attribution engine 504. The attribution engine 504 tracks the real-world ownership, control, publishing or other conditional rights of any RWE in any IO. Whenever a new IO is detected by the W4 engine 502, e.g., through creation or transmission of a new message, a new transaction record, a new image file, etc., ownership is assigned to the IO. The attribution engine 504 creates this ownership information and further allows this information to be determined for each IO known to the W4 COMN.

The W4 engine 502 further includes a correlation engine 506. The correlation engine 506 operates in two capacities: first, to identify associated RWEs and IOs and their relationships (such as by creating a combined graph of any combination of RWEs and IOs and their attributes, relationships and reputations within contexts or situations) and second, as a sensor analytics pre-processor for attention events from any internal or external source.

In one embodiment, the identification of associated RWEs and IOs function of the correlation engine 506 is done by graphing the available data. In this embodiment, a histogram of all RWEs and IOs is created, from which correlations based on the graph may be made. Graphing, or the act of creating a histogram, is a computer science method of identifying a distribution of data in order to identify relevant information and make correlations between the data. In a more general mathematical sense, a histogram is simply a mapping mi that counts the number of observations that fall into various disjoint categories (known as bins), whereas the graph of a histogram is merely one way to represent a histogram. By selecting each IO, RWE, and other known parameters (e.g., times, dates, locations, etc.) as different bins and mapping the available data, relationships between RWEs, IOs and the other parameters can be identified.

As a pre-processor, the correlation engine 506 monitors the information provided by RWEs in order to determine if any conditions are identified that may trigger an action on the part of the W4 engine 502. For example, if a delivery condition has been associated with a message, when the correlation engine 506 determines that the condition is met, it can transmit the appropriate trigger information to the W4 engine 502 that triggers delivery of the message.

The attention engine 508 instruments all appropriate network nodes, clouds, users, applications or any combination thereof and includes close interaction with both the correlation engine 506 and the attribution engine 504.

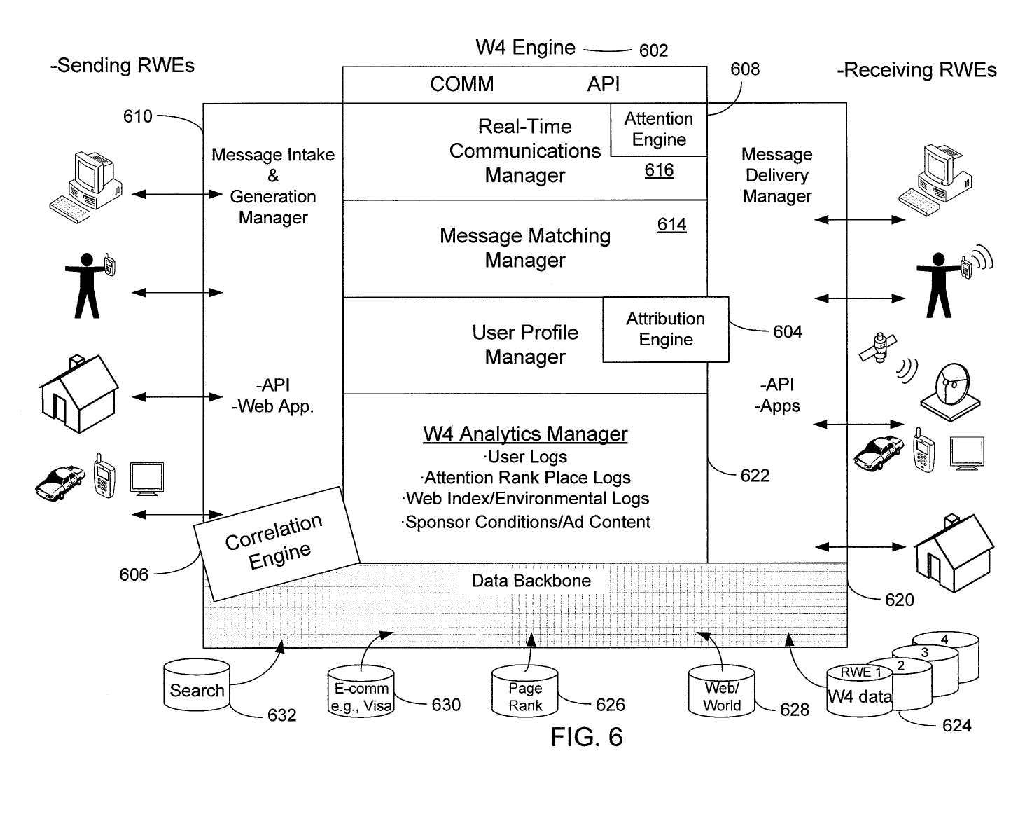

FIG. 6 illustrates an embodiment of a W4 engine showing different components within the sub-engines described generally above with reference to FIG. 4. In one embodiment the W4 engine 600 includes an attention engine 608, attribution engine 604 and correlation engine 606 with several sub-managers based upon basic function.

The attention engine 608 includes a message intake and generation manager 610 as well as a message delivery manager 612 that work closely with both a message matching manager 614 and a real-time communications manager 616 to deliver and instrument all communications across the W4 COMN.

The attribution engine 604 works within the user profile manager 618 and in conjunction with all other modules to identify, process/verify and represent ownership and rights information related to RWEs, IOs and combinations thereof.

The correlation engine 606 dumps data from both of its channels (sensors and processes) into the same data backbone 620 which is organized and controlled by the W4 analytics manager 622 and includes both aggregated and individualized archived versions of data from all network operations including user logs 624, attention rank place logs 626, web indices and environmental logs 618, e-commerce and financial transaction information 630, search indexes and logs 632, sponsor content or conditionals, ad copy and any and all other data used in any W4 COMN process, IO or event. Because of the amount of data that the W4 COMN will potentially store, the data backbone 620 includes numerous database servers and datastores in communication with the W4 COMN to provide sufficient storage capacity.

As discussed above, the data collected by the W4 COMN includes spatial data, temporal data, RWE interaction data, IO content data (e.g., media data), and user data including explicitly-provided and deduced social and relationship data. Spatial data may be any data identifying a location associated with an RWE. For example, the spatial data may include any passively collected location data, such as cell tower data, global packet radio service (GPRS) data, global positioning service (GPS) data, WI-FI data, personal area network data, IP address data and data from other network access points, or actively collected location data, such as location data entered by the user.

Temporal data is time based data (e.g., time stamps) that relate to specific times and/or events associated with a user and/or the electronic device. For example, the temporal data may be passively collected time data (e.g., time data from a clock resident on the electronic device, or time data from a network clock), or the temporal data may be actively collected time data, such as time data entered by the user of the electronic device (e.g., a user maintained calendar).

The interaction data may be any data associated with user interaction of the electronic device, whether active or passive. Examples of interaction data include interpersonal communication data, media data, relationship data, transactional data and device interaction data, all of which are described in further detail below. Table 1, below, is a non-exhaustive list including examples of electronic data.

TABLE 1
Examples of Electronic Data

| Spatial Data | Temporal Data | Interaction Data |
|---|---|---|
| Cell tower data | Time stamps | Interpersonal |
| GPRS data | Local clock | communication data |
| GPS data | Network clock | Media data |
| WiFi data | User input of | Relationship data |
| Personal area network data | time data | Transactional data |
| Network access points data | | Device interaction data |
| User input of location data | | |
| Geo-coordinates data | | |

With respect to the interaction data, communications between any RWEs may generate communication data that is transferred via the W4 COMN. For example, the communication data may be any data associated with an incoming or outgoing short message service (SMS) message, email message, voice call (e.g., a cell phone call, a voice over IP call), or other type of interpersonal communication relative to an RWE, such as information regarding who is sending and receiving the communication(s). As described above, communication data may be correlated with, for example, temporal data to deduce information regarding frequency of communications, including concentrated communication patterns, which may indicate user activity information.

Logical and IO data refers to the data contained by an IO as well as data associated with the IO such as creation time, owner, associated RWEs, when the IO was last accessed, etc. If the IO is a media object, the term media data may be used. Media data may include any data relating to presentable media, such as audio data, visual data, and audiovisual data. For example, the audio data may be data relating to downloaded music, such as genre, artist, album and the like, and includes data regarding ringtones, ringbacks, media purchased, playlists, and media shared, to name a few. The visual data may be data relating to images and/or text received by the electronic device (e.g., via the Internet or other network). The visual data may be data relating to images and/or text sent from and/or captured at the electronic device. The audiovisual data may be data associated with any videos captured at, downloaded to, or otherwise associated with the electronic device. The media data includes media presented to the user via a network, such as use of the Internet, and includes data relating to text entered and/or received by the user using the network (e.g., search terms), and interaction with the network media, such as click data (e.g., advertisement banner clicks, bookmarks, click patterns and the like). Thus, the media data may include data relating to the user's RSS feeds, subscriptions, group memberships, game services, alerts, and the like. The media data also includes non-network activity, such as image capture and/or video capture using an electronic device, such as a mobile phone. The image data may include metadata added by the user, or other data associated with the image, such as, with respect to photos, location when the photos were taken, direction of the shot, content of the shot, and time of day, to name a few. As described in further detail below, media data may be used, for example, to deduce activities information or preferences information, such as cultural and/or buying preferences information.

The relationship data may include data relating to the relationships of an RWE or IO to another RWE or IO. For example, the relationship data may include user identity data, such as gender, age, race, name, social security number, photographs and other information associated with the user's identity. User identity information may also include e-mail addresses, login names and passwords. Relationship data may further include data identifying explicitly associated RWEs. For example, relationship data for a cell phone may indicate the user that owns the cell phone and the company that provides the service to the phone. As another example, relationship data for a smart car may identify the owner, a credit card associated with the owner for payment of electronic tolls, those users permitted to drive the car and the service station for the car.

Relationship data may also include social network data. Social network data includes data relating to any relationship that is explicitly defined by a user or other RWE, such as data relating to a user's friends, family, co-workers, business relations, and the like. Social network data may include, for example, data corresponding with a user-maintained electronic address book. Relationship data may be correlated with, for example, location data to deduce social network information, such as primary relationships (e.g., user-spouse, user-children and user-parent relationships) or other relationships (e.g., user-friends, user-co-worker, user-business associate relationships). Relationship data also may be utilized to deduce, for example, activities information.

The interaction data may also include transactional data. The transactional data may be any data associated with commercial transactions undertaken by or at the mobile electronic device, such as vendor information, financial institution information (e.g., bank information), financial account information (e.g., credit card information), merchandise information and costs/prices information, and purchase frequency information, to name a few. The transactional data may be utilized, for example, to deduce activities and preferences information. The transactional information may also be used to deduce types of devices and/or services the user owns and/or in which the user may have an interest.

The interaction data may also include device or other RWE interaction data. Such data includes both data generated by interactions between a user and a RWE on the W4 COMN and interactions between the RWE and the W4 COMN. RWE interaction data may be any data relating to an RWE's interaction with the electronic device not included in any of the above categories, such as habitual patterns associated with use of an electronic device data of other modules/applications, such as data regarding which applications are used on an electronic device and how often and when those applications are used. As described in further detail below, device interaction data may be correlated with other data to deduce information regarding user activities and patterns associated therewith. Table 2, below, is a non-exhaustive list including examples of interaction data.

TABLE 2
Examples of Interaction Data

| Type of Data | Example(s) |
|---|---|
| Interpersonal | Text-based communications, |
| communication data | such as SMS and e-mail |
| | Audio-based communications, such as voice |
| | calls, voice notes, voice mail |
| | Media-based communications, such as |
| | multimedia messaging service (MMS) |
| | communications |
| | Unique identifiers associated with a |
| | communication, such as phone numbers, e- |
| | mail addresses, and network addresses |
| Media data | Audio data, such as music data (artist, genre, |
| | track, album, etc.) |
| | Visual data, such as any text, images and |
| | video data, including Internet data, picture |
| | data, podcast data and playlist data |
| | Network interaction data, such as click |
| | patterns and channel viewing patterns |
| Relationship data | User identifying information, such as name, |
| | age, gender, race, and social security number |
| | Social network data |
| Transactional data | Vendors |
| | Financial accounts, such as credit cards and |
| | banks data |
| | Type of merchandise/services purchased |
| | Cost of purchases |
| | Inventory of purchases |
| Device interaction data | Any data not captured above dealing with |
| | user interaction of the device, such as |
| | patterns of use of the device, applications |
| | utilized, and so forth |

### Scheduling Meetings and Other Events

One notable aspect of the W4 COMN is the ability to automate the scheduling of events, e.g., meetings, flights, etc., based on the W4 data obtained from the different communications handled by the W4 COMN. W4 smart scheduling is a network personal information management (PIM) operation to personalize and automate the scheduling of personal and professional events through the W4 COMN. By creating a weighted map of requesting RWEs for scheduling access rights and prioritization, decision making logic can determine the best-possible time(s), attendee list and facilities and also automatically manage scheduling changes for any event based upon a request from an authorized user to modify that event's schedule. W4 contextual data is applied to scheduling requests as well as automated requests from processes or software applications. A scheduling user interface may also be used that includes the ability to set complex logic-based temporal definitions, setting conditions and testing criteria/schedules as well as retirement and archiving of past W4 COMN temporal structures or events.

Thus, the W4 COMN supports a fundamentally new, much smarter cross-calendaring system that can automatically optimize common meeting dates among contending calendars with minimal delay and back-and-forth among the actual humans involved. The W4 COMN uses the W4 data in order to prioritize and rank events and schedules and then automatically propose the optimal meeting time and location.

The W4 data used includes data obtained from such things as attendees' social network, corporate organization charts, project team hierarchies, project timelines and the expected flexibility of each attendee/participant based upon their relationships to other participants and the subject of the meeting. In addition, feedback from previously successful meetings can be used to aid the scheduling operation, as well as including other non-explicitly represented events, e.g., earnings call, holiday, birthday, etc., that may not be present as an event record in an attendee's calendar, but would affect the scheduling.

The W4 COMN could also be used to help manage the modification and update functions for changed meetings. For example, an event organizer or attendee could issue a command to the W4 COMN scheduler to cancel, delay or change a meeting. In response the scheduler would cancel, change the time or move the identified meeting and automatically notify all users. Such actions may only be taken if the requestor was sufficiently important to the meeting or had sufficient access rights. Other W4 data, such as traffic, weather, airport congestion, flight delays obtained from RWEs that are related to one or more of the attendees may also be included so that dynamic rescheduling is possible.

In an embodiment, resource conflict resolution is automated based upon the topical and social relations among the requesting parties. Conflicts may then be resolved automatically based on the priority of the meeting to each attendee relative to that attendee's other meetings as well as the relationships between attendees. For example, a meeting request from the Chief Executive Officer (CEO) to a project engineer may be assigned a higher priority than a previously scheduled project meeting. In this example, conflict resolution is automated based upon the topical and social relations among the parties involved.

Computable prioritization of any combination of people and topics within an organization may be combined with location data and previously scheduled events so that the best time and place for a meeting can be chosen. The prioritizations may be generated using lexical scoping so that in certain contexts certain attendees are more valuable and more important to a given meeting than they might otherwise be in the aggregated global prioritization of users. Thus, while the CEO is usually the most important user, depending on the subject matter and expert relationship between other attendees and that subject matter the CEO may not be the highest priority attendee of an event.

The W4 scheduler works for meetings but also works for any context driven scheduling problem where a W4 data model of the attendees, subject matters and their relations allows scheduling to be automatically prioritized and ranked into a set of preferred scheduling solutions that a calendar or other program can then implement to effectuate the scheduling goals. For example, scheduling a new meeting might require some attendees to make other changes in their schedules to be able to attend. To achieve this, the W4 COMN may a) automatically change the event records of conflicting events on some of the attendee's calendars if the changes are within auto-changing rights granted by those users or b) semi-automatically change conflicting events by transmitting a change request including the reasons for the requested change to users. Different types of changes may be provided with different levels of access rights. For some types of changes, e.g., late starts or cancellations due to traffic or delayed flights, auto modification may be used while for other types of changes, e.g., adding or substituting an attendee, approval may be requested from the even organizer and must be received before the change is made to the scheduled event.

In an embodiment, W4 scheduling may be used in a hospital or medical treatment context. In one embodiment, the optimal scheduling of patients may be achieved by prioritizing patients based upon current diagnosis, current vital signs as collected by various RWEs (e.g., pulse and oxygen meter, respiration monitor, electrocardiograph, etc.), patient conditions, stage of disease, threat to life, relationship to the doctor or hospital and the system may output a prioritized list for patients to be seen by available doctors. The list can then be automatically updated as new patients arrive and are added to the list or as the status/condition of existing patients change.

In another embodiment, W4 scheduling may be used in a social network management context. For example, the W4 COMN scheduling system could be used to suggest activities with other users based on the importance of those activities to the other users (as indicated by their W4 data). Alternatively, the system could be used to suggest partners for activities on a personalized basis, starting with those users that are close to the event organizer in a social network and then expanding outward. The system could recommend both an instance (specific event) or class (type of event) as well as specific users and/or groups of users.

For the purposes of this description, communication refers to any message of any format that is to be delivered from one RWE to another via the W4 COMN or via some third party network or communication channel. Thus, a communication includes an email message from one email account to another, a voicemail message left for a computing device such as cell phone, an IM transmitted to a cell phone or computing device, an event request or change transmitted to a list of attendees, or a packet of data transmitted from one software application to another on a different device. A communication will normally take the form of an IO that is created by one RWE and transmitted to another over the W4 COMN or a third party. A communication may also be a stream of data, delivery then being the opening of the connection with the recipient RWE so that the stream is received.

Delivery refers to the delivery of the actual data, e.g., the event request data containing the initial event information, to the target recipient, e.g., the appropriate scheduler software on a computing device. In addition, delivery also refers to the act of notifying the target recipient RWE of the existence of the communication. For example, delivery refers to the situation in which an email account shows that an email or meeting request message has been received in the account's inbox, even though the actual contents of the message have not been received, as occurs when the message is retrieved from a remote location only when it is opened by the account owner.

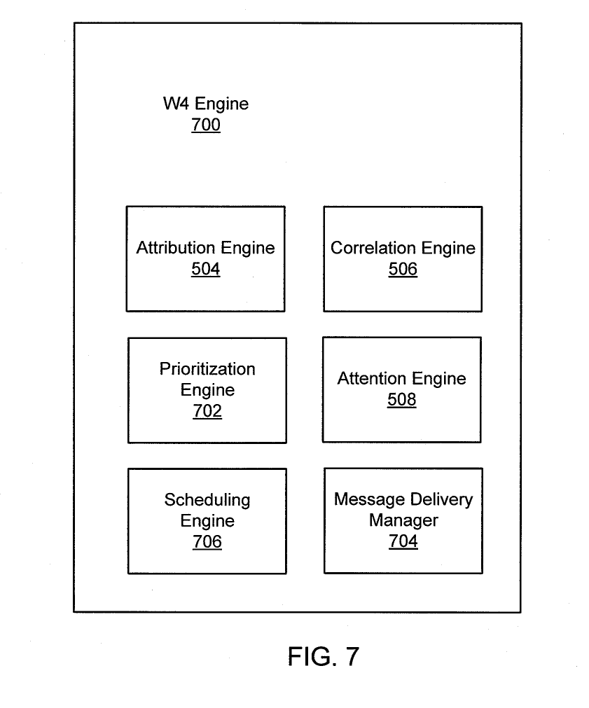

FIG. 7 illustrates some of the elements in a W4 engine adapted to perform W4 scheduling of events as described herein. The W4 engine 700 includes a correlation engine 506, an attribution engine 504 and an attention engine 508 as described above. In addition, the W4 engine includes a prioritization engine 702 that, based on the relationships between IOs and RWEs determined by the correlation engine 506 as described below, generates a prioritization rank, or priority score, for the event relative to each invited RWE. As described in greater detail below, each priority score for an event relative to an invited RWE may reflect the relationships identified by the correlation engine between the RWE and the event organizer, the RWE and the other invited or confirmed attendees, and/or the RWE and other details about the event such as the topic of the event, the location of the event, and/or the time of the event.

The system 700 further includes a scheduling engine 706 that receives an event request, obtains the relative priority of the event for each of the attendees from the prioritization engine 702, and then resolves conflicts in order to generate one or more proposed events that best match the time, location and attendee list of the originally requested event. For the remainder of this discussion, a “proposed event” is an event that has been automatically generated by the scheduling engine 706 based on the relative importance of the event to the attendees, any previously-scheduled events on each of the attendees' electronic calendars, and any other W4 data that the scheduling engine 706 may take into account, e.g., event information not on an attendee's calendar but known to be important to the attendee or location data for an attendee indicating that the attendee will not be near a required event location. A proposed event may differ little or greatly from an initial event identified in an event request. For example, the times, locations and attendees of the events may differ, although the topic will generally be the same.

The scheduling engine 706 evaluates the initial event request, the priority scores from the prioritization engine 702 and W4 data known about the attendees including any previously scheduled events on their calendars to, as best as possible, resolve conflicts and generate a list of one or more proposed events. The list of proposed events (including such information as location, time, attendees, etc.) may then be transmitted to the event organizer or attendees to allow the event organizer to choose one of the events.

The system includes a message delivery manager 704 which delivers event requests including initial requests for new events and subsequent requests to cancel or change the events after they have been accepted by an RWE or otherwise placed in the RWE's electronic calendar. Depending on the embodiment, the scheduling engine 706 may provide directions to the message delivery manager 704 on when/how to deliver event-related messages. In addition, the delivery manager 704 may alert the scheduling engine 706 when there are changes entered into an existing event record by an RWE. Thus, the delivery manager 706 can be considered to handle delivering event information from an RWE to the scheduling engine 706 so that the new event information can be reconciled with that contained in event records for other attendees. As discussed above with reference to the W4 engine, the W4 engine and its various components (hardware, software and/or firmware) and sub-engines could be implemented on a server computer or other suitable computing device or distributed across a number of computing devices.

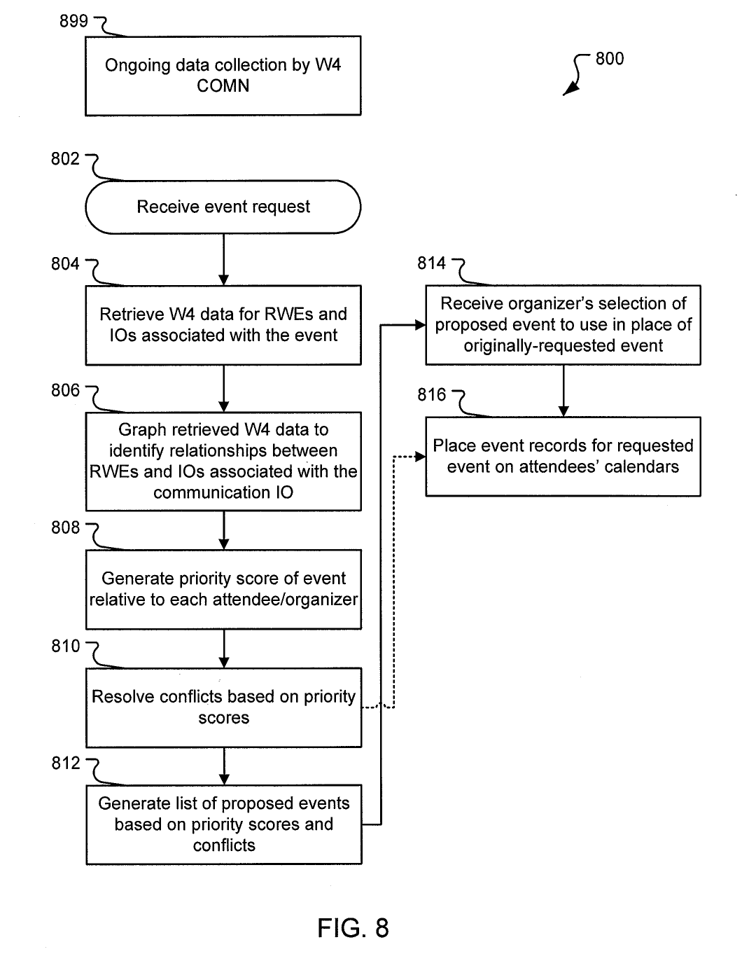

FIG. 8 illustrates an embodiment of a method for scheduling an event using social, temporal, spatial and topical data for entities on a network. In the embodiment described below, depending on how the architecture is implemented, the operations described may be performed by one or more of the various engines described above. In addition, sub-engines may be created and used to perform specific operations in order to improve the network's performance as necessary.

As described above, a foundational aspect of the W4 COMN that allows for prioiritization is the ongoing collection and maintenance of W4 data from the RWEs interacting with the network. In an embodiment, this collection and maintenance is an independent operation 899 of the W4 COMN and thus current W4 social, temporal, spatial and topical data are always available for use in prioritization. In addition, part of this data collection operation 899 includes the determination of ownership and the association of different RWEs with different IOs as described above. Therefore, each IO is owned/controlled by at least one RWE with a known, unique identifier on the W4 COMN and each IO may have many other associations with other RWEs that are known to the W4 COMN.

In the embodiment shown, the method 800 is initiated when a future event request is received by the W4 COMN in a receive event request operation 802. Such a future event request may be generated by a computing device operated by the event organizer using calendar software on the organizer's computing device. In an embodiment, a future event request may be a message (i.e., an IO) that is addressed to the calendar software or email account of the attendees and contains the event information as initially selected by the event organizer. Alternatively, the future event request could be a request transmitted to the event scheduling engine which contains event information as initially selected by the event organizer. Such event information may include a list of attendees (e.g., their email addresses), a topic or other description of the event, a time (e.g., date and hour) for the event, a location for the event and additional information such as attached files, messages or data related to the event. In an alternative embodiment, the event information provided by the organizer may be only a topic and a time frame (e.g., designated range of times) from which the scheduling engine automatically suggests a list of attendees (which may be prioritized), a location and a time.

The receive event request operation 802 may include receiving an actual IO from an IO such as a calendar software being executed by an RWE. In addition, the receive communication operation 802 also includes situations in which the W4 COMN is alerted that there is a change that affects a previously scheduled event. For example, a flight management system may indicate that a flight associated with an attendee is late. This information may be delivered to the scheduling engine which then resolves conflicts based on the new information to determine if the affected event should be changed or not in response.

In any case, an event is described by event information identifying at least one RWE who may also be the event organizer and the event organizer. The attendees and event organizer may be identified by some identifier (e.g., an email address or a telephone number) contained in the event information. Note that the attribution engine may be called on to identify the event organizer in the event that the information is not contained or already provided with the event request. In an embodiment, the organizer and attendees may be identified by a communication channel-specific identifier (e.g., an email address or a telephone number). From these channel-specific identifiers the W4 COMN can determine the unique W4 identifier for the various parties and, therefore, identify all W4 data stored by the system, regardless of the source of the information, for each of the parties. In an embodiment, an event request may also include one or more unique W4 identifiers for IOs or RWEs related to the event (e.g., included as the topic or in the description of the event) which may obviate the need to correlate a channel-specific identifier with a unique W4 identifier.

The receive event request operation 802 may also include an initial analysis of the event information and identification of such things as the topic of the event, when and where the event is initially request to take place, and identification other RWEs referred to in the communication (e.g., people listed in an event description but that are neither an organizer nor attendee or specific equipment or type of equipment that may be needed such as teleconference systems, slide projectors, demonstration equipment, vehicle, etc.) or other IOs (e.g., hyperlinks to IOs, attachments, etc.) related to the event.

The event request may or may not be provided with prioritization information, such as organizer-selected priority ranking or some other information intended to the affect the prioritization of the event. In an embodiment, the event information may include an event organizer's designation of the relative importance of any or all of the event information, e.g., the relative importance of each attendee, the time, and/or the location of the event. For example, in an embodiment, the organizer may be able to flag each attendee as “required”, “optional” or “FYI”. Alternatively, the organizer may be able to numerically rank each attendee as more or less important. Likewise, the organizer may be able to designate a specific event time or location as “required” or, alternatively, identify an acceptable range of times or list of acceptable locations for the event.

The receive event request operation 802 may be considered to occur at any point in the delivery chain within the W4 COMN, e.g., by any one of the engines used to conduct IO intake, routing or delivery. For example, depending on how the W4 COMN operators choose to implement the network functions, an event request may be received and initially analyzed and routed to the scheduling engine by any one of the message intake and generation manager, user profile manager, message delivery manager or any other engine or manager in the W4 COMN's communication delivery chain.

In response to receiving the event request, a data retrieval operation 804 is performed. In the data retrieval operation 804, data associated with the organizer, the attendees, and any other RWEs or IOs related to the event, e.g., locations, topics and specific pieces of equipment, are retrieved. In an embodiment, the data retrieval operation 804 further includes retrieval of additional W4 data up to all of the W4 data stored in order to perform the graphing operation 806 described below. The amount and extent of available data that is retrieved may be limited by filtering which RWE's and IO's data are retrieved. Such W4 data retrieved may include social data, spatial data, temporal data and logical data associated with each RWE. For example, data for past events may be retrieved such as historical attendance or scheduling data for each listed attendee and for attendees of prior events on the same topic. As discussed above, such W4 data may have been collected from communications and IOs obtained by the W4 COMN via many different communication channels and systems, including any electronic calendar software or event records associated with different RWEs such as the organizer and the attendees.

For example, an event request may be emailed by an organizer to multiple attendees/recipients and, because the organizer and the attendees can be resolved to existing RWEs using information known to the email communication network, the unique W4 identifier for those RWEs may be determined. Using the unique W4 identifiers, then, the W4 COMN can identify and retrieve all W4 data associated with the organizer and attendees, including information obtained from other communication channels. Thus, such W4 data as time and location data obtained from cellular telephone communications for each of the sender and recipient RWEs, social network information for each of the sender and recipient RWEs (e.g., who are listed as friends, co-workers, etc. for each of the sender and recipient RWEs on social network sites), project and organizational data (e.g., what position in an organizational chart and what association each RWE has to a project) and what topics have been discussed when in previous communications by each of the attendee RWEs.

The method 800 graphs the retrieved W4 data in a graphing operation 806. In the graphing operation 806, correlations are made for and between each of the RWEs associated with the event information based on the social data, spatial data, temporal data and logical data associated with each RWE. In one sense, the graphing operation 806 may be considered a form of comparing the retrieved social data, spatial data, temporal data and logical data for each RWE with the retrieved data associated with the other RWEs of the event and the event information.

Thus, in an embodiment, the graphing operation 806 may be considered a set of independent operations in which, each operation determines the relationships between a specified RWE and the other RWEs and the event information. For example, a first graphing operation may be performed to determine the relationships between the organizer and the listed attendees, the topic, and the location. A second graphing operation may be performed to determine the relationships between the first listed attendee and the organizer, the other listed attendees, the topic, and the location. Likewise, a third graphing operation may be performed from the point of view of the second listed attendee, and so. Such multiple graphing operations allow the personal differences in perspectives and relationships to be determined and subsequently used when generating priority scores for the event for each attendee. For example, a topic may be very important to an organizer that is relatively low in an organization hierarchy, but may be of little importance to an attendee very high up in the organization hierarchy. By mapping these different relationships, it allows them to be compared and prioritized based on the perspectives of all attendees and not just the perspective of the organizer. Such mapping may include qualifying and normalizing requests across a company or predefined group of RWEs.

Based on the results of the graphing operation 806, a priority score of the event for each RWE (i.e., organizer, attendee and other related RWEs) is generated in a priority score generation operation 808. A priority score is a value representing the relative importance of the event to the given RWE. In an embodiment, for each RWE known to the system a priority score may be generated. In such a situation, the priority score for RWEs that are not included as an organizer, attendee or related party, it is unlikely that the priority score for those RWEs will be very high (this may be achieved by using a weighting factor, as discussed below, so that attendees rate an event higher than non-attendees by some factor). However, in some situations it may be possible for the scheduling system to generate a high priority score for the event to an unassociated RWE. For example, an event may be a high priority event for a newly hired employee with designated project responsibilities based on the event's topic, even though the employee was not listed as an attendee. As another example, an event may be a high priority event to a project manager that is not invited or even listed as an attendee because of the importance of the topic or one of the attendees to the project.

The priority score generated may take into account the relative priority of the event and its topic to both the organizer and the attendees of the event. The priority score generated may take into account such W4 information known to the W4 COMN and allows the probability to reflect W4 data received from different communication channels and associated with the different parties.

In an embodiment, the generation operation 808 independently generates a different priority score for the event for each attendee of the event if there is more than one. Each priority score is determined based on the relationships between that attendee and the other RWEs (e.g., the organizer and other attendees) and event information for the event as determined based on their W4 data. As the relationships are likely to differ between parties, the same event may be provided a different priority score for each attendee.

The generation operation 808 may include generating, for each attendee, a set of priority scores for each RWE, topic and other identifiable element associated with the event and then aggregating these priority scores to obtain a priority score describing the overall importance of the event to that attendee. For example, a priority score for attendee A may be an aggregation of a priority score of the organizer to attendee A, of the topic to the attendee A, of each of the other attendees to attendee A, and/or of the topic to the organizer. Such a priority score for attendee A may further reflect attendee A's track record or explicit priority preferences, e.g., no meetings below a selected priority threshold.

In an embodiment, for example, the generation operation 808 in order to determine a priority score for an event for a given attendee “A”, each relationship between attendee A and the other attendees is identified and given a priority score. This results in a set of priority scores, each describing the relationship between attendee A and another attendee. In addition, the relationship between attendee A and the topic is also identified and a priority score is generated to describe the importance of that relationship, as well. Other relationships may also identified and a priority score generated for each.

In an embodiment, the generation operation 808 takes into account information contained within the event request in that the priority score generated for each attendee will indicate a higher priority if the results of the graphing operation 806 show that the recipient has a strong relationship with the other attendee, topic, organizer, etc. The strength of a relationship may be determined by identifying how many previous communications or IOs have been transferred between or related to the parties. For example, if the topic of the event is a person and the recipient has a strong relationship to that person (e.g., as indicated from previous communications with or about that person or based on information, such as social network information, that identifies some important social relationship with that person), then the priority score will be greater than that generated for a communication about a person to which the recipient has no known relationship.

In an embodiment, the value of the priority score of an event for an attendee may also be determined in part based on the relationship between the organizer of the event and the attendee. This determination includes determining a relationship between the organizer and the attendee based on the retrieved social data, spatial data, temporal data and logical data for each. This relationship may be implicit and determined as a result of the correlations identified during the graphing operation 806. Alternatively, the relationships may be explicit, such as an employment or business organization relationship, and simply retrieved as part of the data retrieval operation 804. Actual past attendance to prior events can also be used to bias or weight specific relationships.

In yet another embodiment, the value of the priority score may also reflect the importance of the topic to the organizer. Such may be determined based on organizer-provided priority information (e.g., a selection of a high importance status by the organizer when requesting the event) or, alternatively, by determining the relationship of the topic of the event with the organizer. If the topic is determined to be highly important to the organizer, then the priority score of the event may be relatively higher than an event which does not have a strong relationship with the organizer.

Another factor in the generation of a priority score is a temporal factor as determined by analysis of the temporal data associated with the event. For example, the time of the event (e.g., the initially designated date and hour) may be compared to the current time and to the time of other events and the priority score of the event may reflect how close the time of the upcoming event is to the current time and the times of other events. If the event is months away, the priority score may be unaffected by the temporal data. However, if the meeting is hours away, then a relatively higher priority score may be generated for the communication.

In an embodiment, a priority score be modified to reflect information contained in an event description. For example, an event description that requests discussion on the topic to be no more than 30 minutes may be used to modify the priority score for the event based on the time limit or a correlation between the time limit and the topic. In addition, various users may have a predefined threshold of never accepting meetings greater than 30 minutes in length.

Yet another factor may be spatial. For example, if the event has a spatial component, e.g., the event is to be at a specific restaurant, the priority score generated for the communication may differ depending on the relative proximity of the attendee to the restaurant, as indicated by W4 data identifying the current or recent location of the recipient. Such information may be determined, for example, from information obtained from a sensor or cell phone associated with the recipient. Likewise, past history with that location for a user may impact priority scores.

More complicated priority scores may also be generated. For example, in an embodiment a combined attendee-topic priority score may be generated in addition to priority scores for each attendee and the topic. Such a combined attendee-topic priority score may account for how important that topic is to the other attendees. For example, even though a topic may not be important to attendee A it may be important to attendee B. If attendee B is important to attendee A, then a combined attendee-topic priority score may be generated that indicates that the event should be a high priority to attendee A by virtue of attendee A's relationship with attendee B and attendee B's relationship with the topic. Likewise, a combined time-topic priority score may be used generated based on meeting requests around topics with known deadlines.

The attendee-topic priority score is an example of one way the individual priority scores for attendee A can be weighted in order to achieve a more accurate representation of the importance of the event to attendee A. By weighting the individual priority scores, the various relationships identified between the topic data, the temporal data, spatial data, and the organizer and attendees of the communication may not be treated equally when aggregating them into an event priority score. In order to obtain more accurate results, different relationships and different types (social, spatial, topical, temporal, etc.) of relationships may be assigned different weights when generating a priority score. For example, relationships based on spatial and temporal correlations may be assigned a greater relative weight than relationships based solely on social relationships. Likewise, relationships based on the relative frequency and topic of communications between two parties may be assigned a weight different from that accorded to a explicit designation that the two parties are friends, family members, etc. Thus, relationships could be determined by comparing current contact attributes of the attendee and the organizer, by comparing location data for each of the attendee and the organizer in which the location data including a set of time and location combinations associated with the respective attendee or organizer, by comparing past contact attributes of the attendee and the organizer, retrieving at least one relationship previously selected by one of the attendee and the organizer, and identifying previous messages between the attendee and the organizer.

As described above, in an embodiment the W4 COMN may generate, for each RWE known to the system, priority scores for some or all of the other RWEs, topics and RWE-topic combinations known to the W4 COMN. Such priority scores may be generated dynamically in response to new requests or the receipt of updated information. Alternatively, the W4 COMN may generate these priority scores periodically, e.g., every day or every few hours, as a standard procedure. In this case, the priority score generation operation 808 may be done independently and these priority scores may be retrieved as needed for the generation of each attendee's priority score of the requested event.

The correlation and comparison process of the generate a priority score operation 808 can determine relationships between parties, topics, locations, etc. in part though the W4 COMN's identification of each RWE by a unique identifier and storage of information about the past interactions by those RWEs. The actual values obtained as priority scores by the generation operation 808 may vary depending on the calculations performed and weighting factors used. Any suitable method or algorithm for generating a value from different relationships identified in the data may be used. For example, all probabilities may be normalized to some scale or may be aggregated without normalization.

In an embodiment, the W4 data are processed and analyzed using data models that treat data not as abstract signals stored in databases, but rather as IOs that represent RWEs that actually exist, have existed, or will exist in real space, real time, and are real people, objects, places, times, and/or events. As such, the data model for W4 IOs that represent W4 RWEs (Where/When/Who/What) will model not only the signals recorded from the RWEs or about the RWEs, but also represent these RWEs and their interactions in ways that model the affordances and constraints of entities and activities in the physical world. A notable aspect is the modeling of data about RWEs as embodied and situated in real world contexts so that the computation of similarity, clustering, distance, and inference take into account the states and actions of RWEs in the real world and the contexts and patterns of these states and actions.

For example, for temporal data the computation of temporal distance and similarity in a W4 data model cannot merely treat time as a linear function. The temporal distance and similarity between two times is dependent not only on the absolute linear temporal delta between them (e.g., the number of hours between “Tuesday, November 20, 4:00 pm Pacific Time” and “Tuesday, November 20, 7:00 pm Pacific Time”), but even more so is dependent on the context and activities that condition the significance of these times in the physical world and the other W4 RWEs (people, places, objects, and events) etc.) associated with them. For example, in terms of distance and similarity, “Tuesday, November 20, 4:00 pm Pacific Time” and “Tuesday, November 27, 4:00 pm Pacific Time” may be modeled as closer together in a W4 temporal data model than “Tuesday, November 20, 4:00 pm Pacific Time” and “Tuesday, November 20, 7:00 pm Pacific Time” because of the weekly meeting that happens every Tuesday at work at 4:00 pm vs. the dinner at home with family that happens at 7 pm on Tuesdays. Contextual and periodic patterns in time may be important to the modeling of temporal data in a W4 data model.

An even simpler temporal data modeling issue is to model the various periodic patterns of daily life such as day and night (and subperiods within them such as morning, noon, afternoon, evening, etc.) and the distinction between the workweek and the weekend. In addition, salient periods such as seasons of the year and salient events such as holidays also affect the modeling of temporal data to determine similarity and distance. Furthermore, the modeling of temporal data for IOs that represent RWEs should correlate temporal, spatial, and weather data to account for the physical condition of times at different points on the planet. Different latitudes have different amounts of daylight and even are opposite between the northern and southern hemispheres. Similar contextual and structural data modeling issues arise in modeling data from and about the RWEs for people, groups of people, objects, places, and events.

With appropriate data models for IOs that represent data from or about RWEs, a variety of machine learning techniques can be applied to analyze the W4 data. In an embodiment, W4 data may modeled as a “feature vector” in which the vector includes not only raw sensed data from or about W4 RWEs, but also higher order features that account for the contextual and periodic patterns of the states and action of W4 RWEs. Each of these features in the feature vector may have a numeric or symbolic value that can be compared for similarity to other numeric or symbolic values in a feature space. Each feature may also be modeled with an additional value from 0 to 1 (a certainty value) to represent the probability that the feature is true. By modeling W4 data about RWEs in ways that account for the affordances and constraints of their context and patterns in the physical world in features and higher order features with or without certainty values, this data (whether represented in feature vectors or by other data modeling techniques) can then be processed to determine similarity, difference, clustering, hierarchical and graph relationships, as well as inferential relationships among the features and feature vectors.

A wide variety of statistical and machine learning techniques can be applied to W4 data from simple histograms to Sparse Factor Analysis (SFA), Hidden Markov Models (HMMs), Support Vector Machines (SVMs), Bayesian Methods, etc. Such learning algorithms may be populated with data models that contain features and higher order features represent not just the “content” of the signals stored as IOs, e.g., the raw W4 data, but also model the contexts and patterns of the RWEs that exist, have existed, or will exist in the physical world from which these data have been captured.

The method 800 also resolves conflicts with previously scheduled events in the various attendees electronic calendars in a resolve conflict operation 810. In the resolve conflict operation 810 previously scheduled events in the various attendees calendars, which were retrieved in data retrieval operation 804, are identified and their priority scores either retrieved or generated. This allows the priority score of previously scheduled events for each attendee to be compared with that attendee's priority score of the requested event. The results of the comparison may indicated that the previously scheduled event is of a lesser priority and could be moved to allow for the scheduling of the higher priority requested event. Alternatively, the previously scheduled event may be of a higher priority and the request event should be changed to eliminate the conflict. Each user with conflicting events will thus have a relative priority differential based upon the individual events' priority scores. This differential may be further used to resolve conflicts between users.

Based on the results of the resolve conflict operation 810, a generate proposed events operation 812 identifies one or more proposed events based on each attendee's priority scores for the requested event and any identified conflicts. As discussed above, when generating proposed events various ranges or constraints that were provided by the organizer may be used to further order and identify the proposed events.

Each proposed event may vary any one or more of the parameters of the event including the topic (while normally static the topic may be modified under certain circumstances such as when a topic is added to previously scheduled event in order to combine the requested event with the previously scheduled event or in response to a request from an attendee to modify or add to the scope of the event), the attendees, time, location, etc. For each proposed event, proposed event information is generated including an event time, an event location and a subset of attendees that can attend at that event time and location based on the information contained in the attendees' user data. For example, low priority attendees (e.g., from the organizer's perspective) may be dropped from proposed events based on identified conflicts in order to meet other limitations such as a specified time range for the event. In addition, this may be performed automatically, e.g., the organizer may be notified as part of displaying the proposed events to the organizer that if a low priority attendee is removed, the event may be scheduled earlier than if that attendee were retained. As another example, a proposed event may identify a different location or time and location combination for the event based on the attendees' location data. For instance, if there are two attendees and their W4 data indicates that they will both be in New York at the same time near the requested event time, then the scheduling engine may use that information to generate a proposed event with New York as the event location.

In addition, new attendees, locations, or other RWEs may be substituted for those initially identified based on relationship information derived from the W4 data. For example, if the requested event identified a systems analyst as an attendee based on that person's expertise, the proposed event that is generated may substitute a different person with the same expertise allowing the organizer to decide if the originally identified systems analyst is so important to the event that it should be delayed until that person is available.

In an embodiment, these proposed events may be transmitted to the organizer allowing the organizer to select one of the proposed events or, alternatively, allowing the organizer to adjust the event information and issue a new event request with altered event parameters. In an alternative embodiment, the selection of a proposed event may be completely automated and performed by the scheduling engine, for example based on the organizer's predetermined scheduling criteria.

The conflict resolution operation 810 may identify no conflicts. In embodiments of the method 800 in which no conflicts are identified, the generate proposed events operation 812 may be bypassed and the event may be placed on each attendee's calendar automatically or a communication may be transmitted to attendees prompting them to accept the event and place it onto their electronic calendar. This is shown by the dotted process flow line from the conflict resolution operation 810 to the revise calendars operation 816.

In addition, the conflict resolution operation 810 may, based on its comparison, determine that the priority of the requested event is sufficiently more important than the priority any of the previously scheduled events on the attendees' calendars, that the generate proposed events operation 812 should be skipped. In this situation, the event may be placed on each attendee's calendar automatically or a communication may be transmitted to attendees prompting them to accept the event into their calendar. In addition, any lesser importance events that have been previously scheduled and that conflict with the requested event may also be automatically moved or the various attendees of those events may be prompted to move those events. Again, this is shown by the dotted process flow line from the conflict resolution operation 810 to the revise calendars operation 816.

If the generate proposed events operation 812 is not skipped, after transmitting the list of proposed events to the organizer, the organizer makes a selection of one of the proposed events which selection is received in a receive selection operation 814. In an embodiment, the generate proposed events operation 812 can also provided with a set of predetermined scheduling criteria for use in either the creation of the proposed events or the automatic selection of one of the proposed events.

The revise calendars operation 816 is performed when a final version of the event has been determined and accepted (either explicitly or based on predetermined scheduling criteria). As discussed above, this may occur as a result of an organizer selection of a proposed event that resolves conflicts on the various attendees' calendars. Alternatively, this may occur if the priority of the requested event overrides any conflicting events or if there are no conflicting events found.

As mentioned above, the revise calendars operation 816 may include generating and transmitting an event record to computing devices, electronic calendars or PIM software associated with each attendee so that the requested event can be placed on each attendee's calendar. The event record may be part of a request or other prompt transmitted to the attendee so that the event record is not automatically placed on the electronic calendar, but rather placed on the calendar after approval from the attendee is received.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure. For example, the scheduling system and method could be adapted to schedule aircraft flights and passengers, buses and even develop package manifests. By treating each important piece of equipment, package, person and location as different RWEs with identifiable relationships, all-encompassing automatic event and resource scheduling may be performed based on relationships known to the system Numerous other changes may be made that will readily suggest themselves to those skilled in the art and which are encompassed in the spirit of the invention disclosed and as defined in the appended claims.

What is claimed is:

1. A method for scheduling an event comprising:
receiving a request from an event organizer to schedule a future event, the request identifying future event information including a topic and a list of attendees;
retrieving user data associated with each of the attendees;
for each attendee, generating a priority score for the future event based on a comparison of the attendee's user data and the event information;
identifying one or more proposed events based on each attendee's priority score for the future event;
receiving a selection of a proposed event from the event organizer to be used as the future event; and
adding the future event to attendees' calendars in response to receiving the selection.

2. The method of claim 1, wherein retrieving user data further comprises:
retrieving at least one of social data, spatial data, temporal data and logical data associated with each of the attendees.

3. The method of claim 2 further comprising:
identifying, for each proposed event, proposed event information including an event time, an event location and a subset of attendees that can attend at that event time and location based on the information contained in the attendees' user data, the subset of attendees containing at least one of the attendees; and
transmitting a list of the one or more proposed events to the event organizer including the proposed event information for each proposed event.

4. The method of claim 3 further comprising:
identifying, for each attendee, previously scheduled events for the attendee from the attendee's user data; and
selecting the subset of attendees based on a comparison of each attendee's priority score for the future event and each attendee's previously scheduled events.

5. The method of claim 4 further comprising:
for each previously scheduled event of an attendee, identifying a priority score for that previously scheduled event; and
comparing the attendee's priority scores for the future event and that attendee's previously scheduled events.

6. The method of claim 2, wherein generating the priority score further comprises:
identifying topic data in at least one of the attendee's user data, the topic data identifying topics of previous messages associated with the attendee; and
for each attendee, generating the priority score for the future event based on the topic data.

7. The method of claim 1, wherein the future event information received from the organizer includes at least one preferred event time or event location and the method further comprises:
generating the priority score at least in part based on the at least one preferred event time or event location.

8. The method of claim 2, wherein generating a priority score further comprises:
for each attendee,
determining a relationship between the attendee and the organizer based on the retrieved social data, spatial data, temporal data and logical data; and
generating the priority score for the future event based at least in part on the relationship.

9. The method of claim 8, wherein determining a relationship between an attendee and the organizer includes at least one of:
comparing current contact attributes of the attendee and the organizer;
comparing location data for each of the attendee and the organizer, the location data including a set of time and location combinations associated with the respective attendee or organizer;
comparing past contact attributes of the attendee and the organizer;
retrieving at least one relationship previously selected by one of the attendee and the organizer; and
identifying previous messages between the attendee and the organizer.

10. The method of claim 1 further comprising:
collecting user data for a plurality of users including the attendees and the organizer;
for each attendee, generating a relative priority score for each user, each topic and each user-topic combination; and
for each attendee, generating the priority score for the future event based on the relative priority score of the organizer, the relative priority score of the topic, and the relative priority score of the organizer-topic combination.

11. The method of claim 10 further comprising:
revising the relative priority scores for the organizer, the topic and the organizer-topic combination based on the future meeting.

12. The method of claim 1, wherein identifying one or more proposed events further comprises:
identifying a location for each attendee associated with each proposed event based on the attendee's user data.

13. The method of claim 5, wherein identifying one or more proposed events further comprises:
changing at least one previously scheduled event of an attendee based on a comparison of the attendee's priority score for the at least one previously scheduled event and the attendee's priority score for the future event.

14. A system for scheduling events comprising:
computer-readable media storing at least one of social data, spatial data, temporal data and logical data associated with a plurality of attendees derived from information objects (IOs) transmitted between computing devices via at least one communication network;
a prioritization engine that, based on the detection of a request from an event organizer to schedule a future event with a list of attendees including a first attendee, generates a priority score for each attendee of the future event based on the at least one of social data, spatial data, temporal data and logical data; and
a scheduling engine that transmits to the event organizer a list of one or more proposed events determined based on each attendee's priority scores for the future event and previously scheduled events.

15. The system of claim 14,
a correlation engine that identifies one or more relationships between the future event, the event organizer and each of the attendees in the list of attendees; and
wherein the prioritization engine generates a priority score for each attendee in the list of attendees based on the one or more relationships identified by the correlation engine between that attendee and at least one of the future event, the other attendees in the list of attendees and the event organizer.

16. The system of claim 15, wherein the correlation engine identifies the topic of the future event and the priority score for a first attendee is generated at least in part based on a relationship between the first attendee and the topic determined from logical data associated with the first attendee.

17. The system of claim 16 further comprising:
wherein the correlation engine identifies the topic of the future event and the priority score for the first attendee is generated at least in part based on a relationship between the first attendee and the topic determined from logical data associated with the first attendee.

18. The system of claim 16, wherein the correlation engine identifies a physical location associated with the future event and the priority score for the first attendee is generated at least in part based on spatial data associated with the first attendee.

19. The system of claim 16, wherein the priority score for the first attendee is generated at least in part based on a relationship between the first attendee and the event organizer.

20. The system of claim 16, wherein each relationship is assigned a weight and the priority score for the first attendee is generated at least in part based on the relative weights of the relationships between the event organizer, the first attendee, and the topic of the future event determined from data for the event organizer and first attendee stored in the computer-readable media.

21. The system of claim 14, wherein if the priority score for the first attendee is within a predetermined range of priority scores, changing a previously scheduled event for the first attendee and placing a selected one of the proposed events in an electronic calendar associated with the first attendee.

22. A computer-readable medium encoding instructions for performing a method for scheduling a future event, the method comprising:
dynamically identifying one or more relationships between a first event attendee and future event information known about the future event;
based on the identified relationships, generating a priority score for the future event; and
placing the future event on an electronic calendar associated with first event attendee based on the priority score.

23. The computer-readable medium of claim 22, wherein the method further comprises:
retrieving one or more of social data, spatial data, temporal data and logical data obtained from previous communications associated with the first event attendee; and
identifying one or more relationships between the first event attendee and the future event information based on the retrieved one or more of social data, spatial data, temporal data and logical data.

24. The computer-readable medium of claim 23, wherein the previous communications include one or more of an electronic mail message from one email account to another, a voicemail message transmitted via a telephone network, an instant message transmitted to a computing device, and a prior event record.

25. The computer-readable medium of claim 22, wherein the method further comprises:
moving at least one previously scheduled event on the electronic calendar based on a comparison of priority scores of the future event and the at least one previously scheduled event.
